(19) United States
(12) Patent Application Publication
(10) Pub. No.: US 2026/0196865 A1
(43) Pub. Date: Jul. 9, 2026

(54) POWER SUPPLY CONTROL DEVICE

(71) Applicants: AutoNetworks Technologies, Ltd., Yokkaichi-shi, Mie (JP); Sumitomo Wiring Systems, Ltd., Yokkaichi-shi, Mie (JP); Sumitomo Electric Industries, Ltd., Osaka-shi, Osaka (JP)

(72) Inventors: Keisuke WAKAZONO, Yokkaichi-shi, Mie (JP); Kazuki MASUDA, Yokkaichi-shi (JP)

(73) Assignees: AutoNetworks Technologies, Ltd., Yokkaichi-shi, Mie (JP); Sumitomo Wiring Systems, Ltd., Yokkaichi-shi, Mie (JP); Sumitomo Electric Industries, Ltd., Osaka-shi, Osaka (JP)

(21) Appl. No.: 19/129,435

(22) PCT Filed: Nov. 15, 2022
(86) PCT No.: PCT/JP2022/042457

§ 371 Date: May 13, 2025

(51) Int. Cl. H02J 9/06; B60R 16/03

(52) U.S. Cl. CPC H02J 9/068; B60R 16/03

(57) ABSTRACT

A power supply control device includes an element unit, a voltage conversion unit, and a control unit. The voltage conversion unit performs a conversion operation of stepping up or down an input voltage that is based on power from a power storage unit. The element unit is capable of allowing flow of a current to a power path side via the element unit itself, and cutting off flow of a current to the power storage unit side via the element unit itself. The control unit stops the voltage conversion unit when supply of power from power source unit to the power path is in a normal state different from a failure state, and causes the voltage conversion unit to start the conversion operation when the failure state is entered.

### CROSS-REFERENCE TO RELATED APPLICATIONS

This application is the U.S. national stage of PCT/JP2022/042457 filed on Nov. 15, 2022, the contents of which is incorporated herein.

### TECHNICAL FIELD

The present disclosure relates to a power supply control device.

### BACKGROUND

JP 2020-182318A discloses an electrical power supply system. The electrical power supply system in JP 2020-182318A includes a main battery and a sub battery and operates so as to switch an electrical power source for a load from the main battery side to the sub battery side when power supply from the main battery side is interrupted. In the electrical power supply system in JP 2020-182318A, a body diode is provided in a switch between the sub battery and the load, and, when power from the main battery is interrupted, power is supplied to the load via the body diode even if the above switch is in an off-state, and thus power supply is not interrupted.

There is concern that, in the electrical power supply system of JP 2020-182318A, when an output voltage of the sub battery drops, an appropriate voltage cannot be supplied to the load.

The present disclosure provides a technique that makes it easy for a power supply control device that can perform a backup operation of supplying power that is based on a power storage unit different from a power source unit, to supply power more quickly and output an appropriate voltage even when an output voltage of the power storage unit changes, during the backup operation.

### SUMMARY

A power supply control device according to an aspect of the present disclosure is a power supply control device that is used in an on-board system including a power source unit configured to supply power, a power path through which power that is based on the power source unit is transmitted, and a power storage unit different from the power source unit, and controls power supply from the power storage unit, the power supply control device including: a first conductive path to which a voltage that is based on output of the power storage unit is applied; an element unit that is electrically connected at one end to the first conductive path; a second conductive path that is electrically connected to the other end of the element unit, and forms a current-carrying path between the element unit and the power path; a voltage conversion unit that is connected in parallel with the element unit between the power storage unit and the power path, and is configured to perform a conversion operation of stepping up or down an input voltage that is based on power from the power storage unit; a third conductive path that is electrically connected to the voltage conversion unit between the voltage conversion unit and the power path; and a control unit configured to control the voltage conversion unit, the element unit being capable of allowing flow of a current to the power path side via the element unit itself and cutting off flow of a current to the power storage unit side via the element unit itself, and the control unit stopping the voltage conversion unit when supply of power from the power source unit to the power path is in a normal state different from a failure state, and causing the voltage conversion unit to start the conversion operation when the failure state is entered.

### Advantageous Effects

The technique according to the present disclosure makes it easy to supply power more quickly, and output an appropriate voltage even when an output voltage of a power storage unit changes, during a backup operation.

### BRIEF DESCRIPTION OF THE DRAWINGS

FIG. 1 is a circuit diagram schematically showing an example of an on-board system that includes a power supply control device according to a first embodiment.

FIG. 2 is a circuit diagram schematically showing an example of a voltage conversion unit.

FIG. 3 is a flowchart illustrating a flow of control for backup that is performed by the power supply control device according to the first embodiment.

FIG. 4 is a circuit diagram schematically showing an example of an on-board system that includes a power supply control device according to a second embodiment.

FIG. 5 is a circuit diagram schematically showing an example of an on-board system that includes a power supply control device according to a third embodiment.

FIG. 6 is a circuit diagram schematically showing an example of an on-board system that includes a power supply control device according to a fourth embodiment.

FIG. 7 is a circuit diagram schematically showing an example of an on-board system that includes a power supply control device according to a fifth embodiment.

### DETAILED DESCRIPTION OF PREFERRED EMBODIMENTS

Embodiments of the present disclosure will be listed and illustrated below. Note that the features of the first to the tenth aspects to be illustrated below may be combined in any manner in which contradictions do not arise.

In a first aspect, a power supply control device that is used in an on-board system including a power source unit configured to supply power, a power path through which power that is based on the power source unit is transmitted, and a power storage unit different from the power source unit, and controls power supply from the power storage unit, the power supply control device including: a first conductive path to which a voltage that is based on output of the power storage unit is applied; an element unit that is electrically connected at one end to the first conductive path; a second conductive path that is electrically connected to the other end of the element unit, and forms a current-carrying path between the element unit and the power path; a voltage conversion unit that is connected in parallel with the element unit between the power storage unit and the power path, and is configured to perform a conversion operation of stepping up or down an input voltage that is based on power from the power storage unit; a third conductive path that is electrically connected to the voltage conversion unit between the voltage conversion unit and the power path; and a control unit configured to control the voltage conversion unit, the element unit being capable of allowing flow of a current to the power path side via the element unit itself and cutting off flow of a current to the power storage unit side via the element unit itself, and the control unit stopping the voltage conversion unit when supply of power from the power source unit to the power path is in a normal state different from a failure state, and causing the voltage conversion unit to start the conversion operation when the failure state is entered.

When performing a backup operation of supplying power that is based on the power storage unit, the power supply control device according to the first aspect can use a path extending via the element unit and a path extending via the voltage conversion unit. In a period during which sufficient power is not supplied through the path extending via the voltage conversion unit, for example, this power supply control device can take measures by quickly supplying power using the path extending via the element unit. On the other hand, when the output voltage of the power storage unit drops, measures can be taken by causing the voltage conversion unit to perform a voltage step-up operation, and performing a backup operation so as to apply a desired output voltage to the third conductive path.

In a second aspect, in the power supply control device according to the first aspect, when the failure state is entered, the control unit causes the voltage conversion unit to start the conversion operation so as to apply an output voltage of a first value to the third conductive path, when a voltage of the second conductive path is lower than or equal to a second value in the failure state, a current flows from the power storage unit side to the power path side via the element unit, and at least after the failure state has been entered, flow of a current from the second conductive path side to the power storage unit side is cut off in the element unit.

The power supply control device according to the second aspect has a configuration in which, when the voltage of the second conductive path is lower than or equal to the second value in the above failure state, a current flows from the power storage unit side to the power path side via the element unit. That is to say, during a period during which output of the voltage conversion unit does not rise to an extent where “the voltage of the second conductive path exceeds the second value”, power that is based on the power storage unit can be supplied to the power path side via the element unit, and thus, in a period during which output of the voltage conversion unit is low, a current can be compensated for using the path extending via the element unit. Furthermore, at least after the above failure state has been entered, flow of a current from the second conductive path side to the power storage unit side can be cut off in the element unit, and thus, while such a cutoff function is being exhibited, a current that is based on output from the voltage conversion unit can be prevented from flowing from the second conductive path side to the power storage unit side.

In a third aspect, in the power supply control device according to the second aspect, after causing the voltage conversion unit to start the conversion operation of applying the output voltage of the first value to the third conductive path when the failure state is entered, the control unit causes the voltage conversion unit to perform the conversion operation of applying an output voltage of a third value that is smaller than the first value to the third conductive path.

In the power supply control device according to the third aspect, after voltage conversion is started so as to apply the output voltage of the first value to the third conductive path when the failure state is entered, the voltage conversion can be switched so as to apply the output voltage of the third value that is lower than the first value. Thus, after a certain period of time has elapsed, this power supply control device can suppress a voltage that is output by the voltage conversion unit, and suppress the output energy.

In a fourth aspect, in the power supply control device according to the third aspect, the second conductive path and the third conductive path are short-circuited to each other, the second value is a value obtained by subtracting a value corresponding to an amount of drop in voltage that occurs in the element unit from a value of a voltage that is applied to the first conductive path, the first value is larger than the second value, and the third value is smaller than the first value and larger than the second value.

The power supply control device according to the fourth aspect can operate such that, when the failure state is entered, voltage conversion is performed so as to apply the output voltage of the first value that is larger than the above second value, and the voltage of the third conductive path is brought closer to a relatively high target voltage (first value) at an early stage. After a certain period of time has elapsed from when the failure state was entered, this power supply control device can also suppress the output energy by suppressing a voltage that is output by the voltage conversion unit to the third value, and can suppress a current flowing via the element unit by setting the third value to a value larger than the second value.

In a fifth aspect, in the power supply control device according to the third aspect, the second conductive path and the third conductive path are short-circuited to each other, the second value is a value obtained by subtracting a value corresponding to an amount of drop in voltage that occurs in the element unit when a current flows from the first conductive path to the second conductive path through the element unit, from a value of a voltage that is applied to the first conductive path, and the third value is smaller than the first value and the second value.

After a certain period of time has elapsed from when the failure state was entered, the power supply control device according to the fifth aspect can suppress the output energy by suppressing a voltage that is output by the voltage conversion unit to the third value, and can suppress the above output energy further by setting the third value to a value smaller than the second value.

In a sixth aspect, in the power supply control device according to the fourth aspect, the element unit includes a diode and an opening/closing portion provided in parallel with the diode, a voltage that is based on output of the power storage unit is applied to an anode of the diode, a cathode of the diode is electrically connected to the second conductive path, in an on-state, bidirectional current-carrying is allowed in the opening/closing portion, when the opening/closing portion is in the on-state, the second value is a first subtracted value obtained by subtracting a value corresponding to an amount of drop in voltage that occurs in the opening/closing portion and the diode, from a value of a voltage that is applied to the first conductive path, and, when the opening/closing portion is in an off-state, the second value is a second subtracted value obtained by subtracting a value corresponding to an amount of drop in voltage that occurs in the diode, from the value of the voltage that is applied to the first conductive path, the first value is larger than both the first subtracted value and the second subtracted value, when a state changes from the normal state to the failure state, the control unit switches the opening/closing portion to the on-state and causes the voltage conversion unit to start the conversion operation of applying the output voltage of the first value to the third conductive path, then switches the opening/closing portion to the off-state if a predetermined condition is satisfied in a state where the voltage conversion unit is performing the conversion operation, and, after switching the opening/closing portion to the off-state, causes the voltage conversion unit to perform the conversion operation of applying the output voltage of the third value to the third conductive path, and the third value is larger than the second subtracted value.

In the power supply control device according to the sixth aspect, the element unit is configured such that the diode and the opening/closing portion are provided in parallel with each other, the anode of the diode is connected to the first conductive path, and the cathode is connected to the second conductive path. Thus, in the element unit, even when the opening/closing portion is in the off-state, a current is continuously permitted to flow from the first conductive path to the second conductive path if the voltage of the second conductive path is lower than the voltage of the first conductive path by a certain value or more, and when the opening/closing portion is in the on-state, current-carrying via the opening/closing portion is permitted. Furthermore, by switching the opening/closing portion to the on-state when the state changes from the normal state to the failure state, this power supply control device can supply a larger amount of power via the element unit at an earlier stage while reducing loss in the element unit. Furthermore, this power supply control device switches the opening/closing portion to the off-state in accordance with the predetermined condition being satisfied during the conversion operation. Thus, after the voltage conversion operation has progressed to a point where the predetermined condition is satisfied, this power supply control device can prevent a current from flowing backward in the element unit. Furthermore, after switching the opening/closing portion to the off-state, this power supply control device can cause the voltage conversion unit to perform the conversion operation of applying the output voltage of the third value (a value smaller than the first value and larger than the second subtracted value) to the third conductive path. Thus, after a certain period of time has elapsed, this power supply control device can continue power supply through an energy-saving output operation performed by the voltage conversion unit, while reliably suppressing a current in a forward direction in the diode.

In a seventh aspect, in the power supply control device according to the sixth aspect, the predetermined condition is that the voltage of the second conductive path has reached a predetermined value that is higher than or equal to a voltage of the first conductive path.

The power supply control device according to the seventh aspect can continue current-carrying via the opening/closing portion until the voltage of the second conductive path rises after the failure state was entered, and, after the voltage of the second conductive path has risen, can reliably prevent a back-flow in the element unit.

In an eighth aspect, in the power supply control device according to the sixth aspect, the predetermined condition is that a predetermined time has elapsed from when the voltage conversion unit started the conversion operation after the failure state was entered.

The power supply control device according to the eighth aspect can continue current-carrying via the opening/closing portion until a predetermined time elapses from when the voltage conversion unit started outputting a current after the failure state was entered, and can reliably prevent a back-flow in the element unit after the predetermined time has elapsed.

In a ninth aspect, in the power supply control device according to the sixth aspect, the predetermined condition is that a current flowing through the element unit has dropped to or below a lower limit value.

The power supply control device according to the ninth aspect can allow current-carrying via the opening/closing portion until a current flowing through the element unit drops to or below the lower limit value after the failure state was entered, and can reliably prevent a back-flow in the element unit when a current flowing through the element unit drops to or below the lower limit value.

In a tenth aspect, in the power supply control device according to the sixth aspect, the predetermined condition is that a current output to the third conductive path by the voltage conversion unit after the failure state was entered has reached a reference value or larger.

The power supply control device according to the tenth aspect can allow current-carrying via the opening/closing portion until a current output to the third conductive path by the voltage conversion unit after the failure state was entered reaches the reference value or higher, and can reliably prevent a back-flow in the element unit when a current output to the third conductive path by the voltage conversion unit has reached a reference value or larger.

### First Embodiment

### Overview of On-Board System

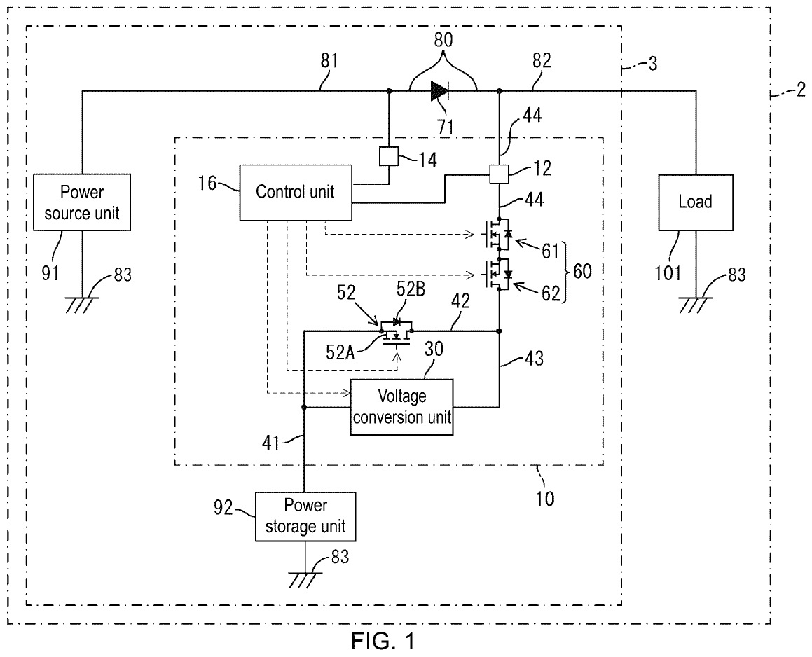

FIG. 1 shows an on-board system 2. The on-board system 2 in FIG. 1 mainly includes an on-board power source system 3 and a load 101. In the following description, the on-board power source system 3 is also referred to as a power source system 3. The on-board system 2 is a system in which the power source system 3 supplies power to the load 101, and thereby causes the load 101 to operate. FIG. 1 illustrates the load 101 as an example of an on-board load, but a load other than this can be provided in the on-board system 2.

The load 101 is an electrical component that is mounted in a vehicle. The load 101 operates by receiving power supplied via a power path 80. The type of load 101 is not limited. Known various on-board components can be adopted as the load 101. The load 101 may include a plurality of electrical components, or may be a single electrical component.

The power source system 3 is a system for supplying power to the load 101. The power source system 3 supplies power to the load 101 using a power source unit 91 or a power storage unit 92 as a power supply source. The power source system 3 can supply power from the power source unit 91 to the load 101, and can supply power from the power storage unit 92 to the load 101, for example, when power supply from the power source unit 91 is interrupted due to a failure or the like.

### Overview of Power Source System

The power source system 3 includes the power source unit 91, the power storage unit 92, a power supply control device 10, the power path 80, a diode 71, and the like.

The power source unit 91 is an on-board power source that can supply power to the load 101. The power source unit 91 is configured as a known on-board battery such as a lead battery. The power source unit 91 may also be configured by a battery different from a lead battery or may include a power source means different from a battery in place of or in addition to the battery. The positive electrode of the power source unit 91 is electrically connected to a first power path 81 that is a portion of the power path 80 in a configuration of being short-circuited to the first power path 81. The negative electrode of the power source unit 91 is electrically connected to a ground 83 in a configuration of being short-circuited to the ground 83. The power source unit 91 applies a DC voltage of a certain value to the first power path 81. The voltage that is applied to the first power path 81 by the power source unit 91 may slightly vary from the above certain value.

The power storage unit 92 is a power source different from the power source unit 91. The power storage unit 92 is a power source that serves as a power supply source at least when power supply from the power source unit 91 is interrupted. The power storage unit 92 is configured by a known power storage means such as an electric double layer capacitor (EDLC). The power storage unit 92 may also be configured by a capacitor different from an electric double layer capacitor, or may include another power storage means (such as a battery) in place of or in addition to the capacitor. The positive electrode of the power storage unit 92 is electrically connected to a first conductive path 41 in a configuration of being short-circuited to the first conductive path 41. The negative electrode of the power storage unit 92 is electrically connected to the ground 83 in a configuration of being short-circuited to the ground 83. An output voltage of the power storage unit 92 (a voltage that is applied to the first conductive path 41 by the power storage unit 92) may be higher or lower than an output voltage of the power source unit 91 (a voltage that is applied to the first power path 81 by the power source unit 91).

In the present specification, a voltage is a voltage relative to a ground potential (for example, 0 V) unless particularly limited, and is a difference in potential from the ground potential. For example, a voltage that is applied to the first power path 81 is the difference between the potential of the first power path 81 and the ground potential. A voltage that is applied to the first conductive path 41 is the difference between the potential of the first conductive path 41 and the ground potential.

The power path 80 is a path through which power that is based on the power source unit 91 is transmitted, and is a path through which power that is based on the power source unit 91 is supplied to the load 101. In the example in FIG. 1, the power path 80 includes the first power path 81 provided on the power source unit 91 side relative to the diode 71, and a second power path 82 provided on the load 101 side relative to the diode 71. A voltage that is the same or substantially the same as the output voltage of the power source unit 91 is applied to the first power path 81. One end of the first power path 81 is electrically connected to the positive electrode of the power source unit 91 in a configuration of being short-circuited to the positive electrode. The other end of the first power path 81 is electrically connected to the anode of the diode 71. A relay or a fuse may be provided on the first power path 81. One end of the second power path 82 is electrically connected to the cathode of the diode 71. In the example in FIG. 1, the second power path 82 is short-circuited to one end of the load 101.

The diode 71 is an element interposed on the power path 80. The diode 71 allows a current to flow from the first power path 81 side to the second power path 82 side on the power path 80, and cuts off flow of a current flow from the second power path 82 side to the first power path 81 side. The diode 71 has a function for preventing a current from flowing from the second power path 82 side to the first power path 81 side when the voltage of the first power path 81 drops significantly below the voltage of the second power path 82, due to the occurrence of a later-described failure state.

### Detailed Description of Power Supply Control Device

The power supply control device 10 is an apparatus that is used in the on-board system 2, and controls power supply from the power storage unit 92. The power supply control device 10 is a backup apparatus capable of outputting power that is based on the power storage unit 92. The power supply control device 10 includes the first conductive path 41, a second conductive path 42, a third conductive path 43, a fourth conductive path 44, a control unit 16, a voltage conversion unit 30, an element unit 52, a switch unit 60, a current detection unit 12, a voltage detection unit 14, and the like.

The first conductive path 41 is a conductive path that is electrically connected to one end of the element unit 52. In the example in FIG. 1, one end of the first conductive path 41 is short-circuited to the one end of the element unit 52, and the other end of the first conductive path 41 is short-circuited to the positive electrode, namely one end of the power storage unit 92. A voltage that is based on output of the power storage unit 92 is applied to the first conductive path 41. In the example in FIG. 1, the potential of the first conductive path 41, the potential of the source of an FET (field effect transistor) that constitutes the element unit 52, the potential of the anode of a diode 52B, and the potential of the one end (positive electrode) of the power storage unit 92 are the same.

The second conductive path 42 is a conductive path that is electrically connected to the other end of the element unit 52. The second conductive path 42 forms a current-carrying path between the element unit 52 and the power path 80. In the example in FIG. 1, one end of the second conductive path 42 is short-circuited to the other end of the element unit 52, and the other end of the second conductive path 42 is short-circuited to the third conductive path 43. In the example in FIG. 1, the potential of the second conductive path 42, the potential of the drain of the element unit 52, the potential of the cathode of the diode 52B, and the potential of the third conductive path 43 are the same. The second conductive path 42 is electrically connected to a conductive path (the third conductive path 43) disposed between the switch unit 60 and the voltage conversion unit 30. In FIG. 1, the connection point between the second conductive path 42 and the third conductive path 43 is denoted by reference sign P1.

The third conductive path 43 is a conductive path disposed between the voltage conversion unit 30 and the switch unit 60. The third conductive path 43 is electrically connected to the voltage conversion unit 30 between the voltage conversion unit 30 and the power path 80. In the example in FIG. 1, one end of the third conductive path 43 is electrically connected to the voltage conversion unit 30, and the other end of the third conductive path 43 is electrically connected to the switch unit 60.

The fourth conductive path 44 is a conductive path disposed between the switch unit 60 and the power path 80. In the example in FIG. 1, one end of the fourth conductive path 44 is electrically connected to the switch unit 60, and the other end of the fourth conductive path 44 is electrically connected to the power path 80. In FIG. 1, the connection point between the fourth conductive path 44 and the power path 80 is denoted by reference sign P2.

The element unit 52 is an element provided between the first conductive path 41 and the second conductive path 42. The one end of the element unit 52 is electrically connected to the first conductive path 41. The other end of the element unit 52 is electrically connected to the second conductive path 42. The element unit 52 can allow flow of a current to the power path 80 side via the element unit 52 itself, and cut off flow of a current to the power storage unit 92 side via the element unit 52 itself. In the example in FIG. 1, the element unit 52 is configured as an N-channel FET, and includes the diode 52B configured as a body diode and an opening/closing portion 52A provided in parallel with the diode 52B. In the example in FIG. 1, the opening/closing portion 52A is a portion of the element unit 52 that is configured as the FET excluding a portion configured as the body diode, and is a portion through which bidirectional current-carrying is allowed in an on-state, and bidirectional current-carrying is cut off in an off-state. Since such a configuration is adopted, a voltage that is based on output of the power storage unit 92 is applied to the anode of the diode 52B. The cathode of the diode 52B is electrically connected to the second conductive path 42.

The switch unit 60 is a switch provided between the third conductive path 43 and the power path 80. In the example in FIG. 1, the switch unit 60 includes a switch element 61 and a switch element 62 configured as N-channel FETs. The drain of the switch element 61 is electrically connected to the fourth conductive path 44. The body diode of the switch element 61 is directed such that the cathode thereof is disposed on the power path 80 side and a current does not flow from the power path 80 side to the third conductive path 43 side via the body diode. The drain of the switch element 62 is electrically connected to the third conductive path 43. The body diode of the switch element 62 is directed such that the cathode thereof is disposed on the third conductive path 43 side, and a current does not flow from the third conductive path 43 side to the power path 80 side via the body diode. In the example in FIG. 1, the switch unit 60 being in the on-state means both the switch element 61 and the switch element 62 being in the on-state, and the switch unit 60 being in the off-state means both the switch element 61 and the switch element 62 being in the off-state. When the switch unit 60 is in the off-state, both the switch elements 61 and 62 are in the off-state, and thus the switch unit 60 cuts off flow of a current from the power path 80 to the third conductive path 43. When the switch unit 60 is in the on-state, both the switch elements 61 and 62 are in the on-state, and thus the switch unit 60 allows current-carrying between the third conductive path 43 and the power path 80 via the switch unit 60 itself.

In the example in FIG. 1, a configuration is adopted in which, whether the switch unit 60 is in the on-state or in the off-state, the second conductive path 42 and the third conductive path 43 are short-circuited to each other without the switch unit 60 being interposed therebetween.

The voltage conversion unit 30 is a device that can step up or down an input voltage. In the example in FIG. 1, the voltage conversion unit 30 is connected in parallel to the element unit 52 between the power storage unit 92 and the power path 80. The voltage conversion unit 30 is configured by a known voltage conversion circuit such as a DC/DC converter.

In the example in FIG. 1, the voltage conversion unit 30 performs voltage conversion between the first conductive path 41 and the third conductive path 43. The voltage conversion unit 30 can perform a first conversion operation of stepping up or down a DC voltage applied to the first conductive path 41, and applying an output voltage to the third conductive path 43. During the first conversion operation, a DC voltage applied to the first conductive path 41 is an input voltage that is based on power from the power storage unit 92. The voltage conversion unit 30 may also have a function for performing a second conversion operation of stepping up or down a voltage applied to the third conductive path 43, and applying the voltage to the first conductive path 41, that is to say a function for performing bidirectional voltage conversion. Operations of the voltage conversion unit 30 are controlled by the control unit 16. Note that the voltage conversion unit 30 includes a voltage sensor that can detect the value of a voltage of the third conductive path 43 and a current sensor that can detect the value of a current flowing through the third conductive path 43, and the control unit 16 specifies the value of the current flowing through the third conductive path 43 and the value of the voltage of the third conductive path 43 by obtaining information from these sensors.

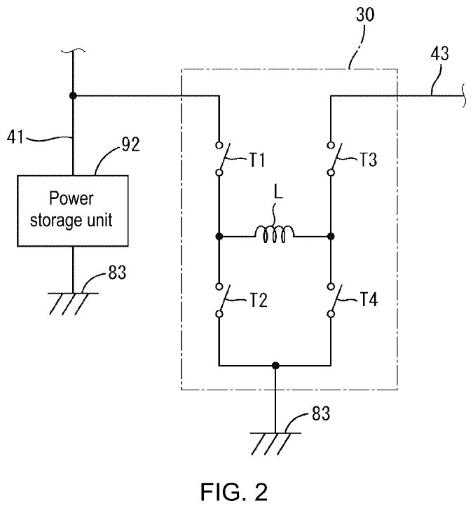

In the example in FIG. 2, the voltage conversion unit 30 includes the switch elements T1, T2, T3, and T4 and an inductor L arranged in a known H-bridge structure, and functions as what is known as a bidirectional buck-boost DC/DC converter. The switch element T1 and the switch element T2 are connected in series between the first conductive path 41 and the ground 83. One end of the switch element T1 is electrically connected to the first conductive path 41 in a configuration of being short-circuited to the first conductive path 41. The other end of the switch element T1 is electrically connected to one end of the switch element T2 and one end of the inductor L in a configuration of being short-circuited to the one end of the switch element T2 and the one end of the inductor L. The other end of the switch element T2 is electrically connected to the ground 83 in a configuration of being short-circuited to the ground 83. The switch element T3 and the switch element T4 are connected in series between the third conductive path 43 and the ground 83. One end of the switch element T3 is electrically connected to the third conductive path 43 in a configuration of being short-circuited to the third conductive path 43. The other end of the switch element T3 is electrically connected to one end of the switch element T4 and the other end of the inductor L in a configuration of being short-circuited to the one end of the switch element T4 and the other end of the inductor L. The other end of the switch element T4 is electrically connected to the ground 83 in a configuration of being short-circuited to the ground 83. The switch elements T1, T2, T3, and T4 are configured as N-channel FETs.

The control unit 16 is a device that controls the voltage conversion unit 30, the element unit 52, and the switch unit 60. The control unit 16 includes an information processing device that has an information processing function, a computation function, a control function, and the like, and may be configured by this information processing device, or may also be configured by a device different from the information processing device. For example, as the control unit 16, a common control device may control all of the voltage conversion unit 30, the element unit 52, and the switch unit 60, or different devices may respectively control the voltage conversion unit 30, the element unit 52, the switch unit 60.

The voltage detection unit 14 is a circuit that provides a detection value (for example, an analog voltage value) with which the value of a voltage applied to the power path 80 can be specified, to the control unit 16. The voltage detection unit 14 may be a circuit that inputs the same voltage value as the value of the voltage applied to the power path 80, to the control unit 16, or may also be a circuit that inputs a value proportional to the value of the voltage applied to the power path 80, to the control unit 16. For example, the voltage detection unit 14 is a voltage-dividing circuit, and a value obtained by the voltage-dividing circuit dividing the value of the voltage applied to the first power path 81 is input to the control unit 16 as a detection value. The control unit 16 specifies the value of the voltage applied to the first power path 81, based on the detection value input from the voltage detection unit 14.

The current detection unit 12 is a current sensor that detects the value of a current flowing through the fourth conductive path 44. A detection value that is input from the current detection unit 12 to the control unit 16 is information with which the value of a current flowing through the fourth conductive path 44 can be specified. The control unit 16 specifies the value of the current flowing through the fourth conductive path 44 based on the detection value input from the current detection unit 12.

### Operations of Power Supply Control Device

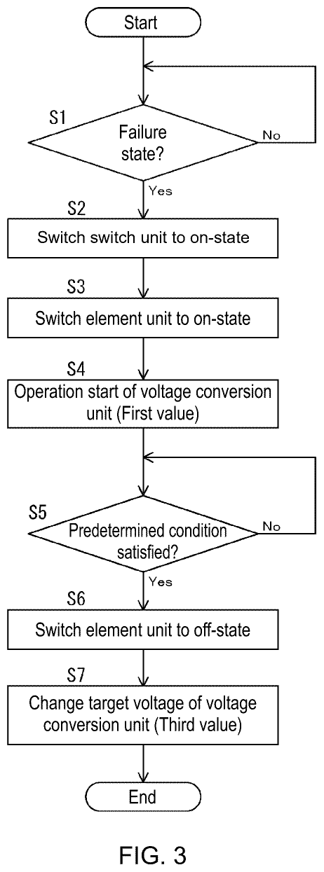

The following description is directed to control for a backup operation that is performed by the power supply control device 10. FIG. 3 is a flowchart showing a flow of control for a backup operation.

When a predetermined start condition is satisfied, the control unit 16 starts control for a backup operation shown in FIG. 3. The above “start condition” may be, for example, a condition that “a vehicle is started”, or may be another condition. In a representative example to be described below, when a vehicle equipped with the on-board system 2 is started, the control unit 16 determines that the above start condition is satisfied, and starts control for a backup operation shown in FIG. 3. A state where a vehicle is started is a state where a starting switch such as an ignition switch in a hybrid vehicle or a power switch in an electric vehicle enters an on-state.

At a time point when control for a backup operation shown in FIG. 3 is started, the control unit 16 determines that the state is a normal state (a state that is not the failure state), and stops the voltage conversion unit 30. Accordingly, power consumption for operating the voltage conversion unit 30 (more specifically the switch elements T1, T2, T3, and T4) is suppressed. The voltage conversion unit 30 stops the voltage conversion unit 30 in the state where flow of a current from the third conductive path 43 side to the ground 83 side via the voltage conversion unit 30 is cut off, for example. More specifically the voltage conversion unit 30 stops the voltage conversion unit 30 in a state where all of the switch elements T1, T2, T3, and T4 that constitute the voltage conversion unit 30 are brought into the off-state. Accordingly, irrespective of the state of the switch unit 60, it is possible to avoid short-circuiting between the power path 80 and the ground 83 in the normal state.

In the state where the voltage conversion unit 30 is stopped, the control unit 16, in step S1, determines whether or not a predetermined failure state has occurred. The failure state is an abnormality state where supply of power from the power source unit 91 to the power path 80 has dropped to a predetermined reference value or stopped. Various known methods can be adopted as a failure state determination method. In a representative example to be described below, a state where the voltage of the first power path 81 dropped to a threshold value or lower is the failure state. The threshold value in this case is lower than the output voltage when the power source unit 91 is fully charged, and is a value of 0 V or higher.

If it is determined in step S1 that the failure state has not occurred, the control unit 16 makes determination of “No” in step S1, and repeats the determination of step S1. In the example in FIG. 3, in a period during which the failure state does not occur after control in FIG. 3 was started, determination on the failure state is continuously repeated until a predetermined end condition is satisfied. Note that, in a representative example to be described below, during a period during which the above failure state does not occur, the control unit 16 maintains both the switch unit 60 and the element unit 52 in the off-state, and stops the voltage conversion unit 30.

If it is determined in step S1 that the failure state has occurred (if “Yes” in step S1), the control unit 16 switches the switch unit 60 to the on-state in step S2, switches the element unit 52 to the on-state in step S3, and causes the voltage conversion unit 30 to start the conversion operation in step S4. In this manner, the control unit 16 stops the voltage conversion unit 30 when power supply from the power source unit 91 to the power path 80 is in the normal state different from the failure state, and causes the voltage conversion unit 30 to start the conversion operation when the failure state is entered.

After switching the switch unit 60 to the on-state in step S2, the control unit 16 switches the element unit 52 to the on-state in step S3. When such a switch is performed, current-carrying via the opening/closing portion 52A and current-carrying via the diode 52B are allowed in the element unit 52, enabling current-carrying while suppressing loss. Note that control for switching the element unit 52 to the on-state by the control unit 16 may be performed simultaneously with step S2, or may be performed before step S2.

In the present embodiment, if the voltage of the second conductive path 42 is lower than or equal to a second value in the failure state, a current flows from the power storage unit 92 side to the power path 80 side via the element unit 52. When the opening/closing portion 52A is in the on-state, the second value is a first subtracted value obtained by subtracting a value corresponding to an amount of drop in voltage that occurs in the opening/closing portion 52A and the diode 52B from the value of the voltage that is applied to the first conductive path 41. When the opening/closing portion 52A is in the off-state, the second value is a second subtracted value obtained by subtracting a value corresponding to an amount of drop in voltage that occurs in the diode 52B from the value of the voltage that is applied to the first conductive path 41. In the present embodiment, a first value is larger than the second value, and, specifically the first value is larger than both the above first subtracted value and the above second subtracted value. The first value is 15 V for example. The second subtracted value is, for example, 10.8 V during a period before the element unit 52 is switched to the on-state in step S3.

A portion of the control unit 16 that executes control in step S3 may be different from a portion that executes control in step S2 and a portion that executes control in step S4. If the portion that executes control in step S3 is provided as a dedicated portion, the dedicated portion may be configured to be able to detect a current flowing through the diode 52B, maintain the element unit 52 in the off-state when no current is flowing through the diode 52B, and execute step S3 and switch the element unit 52 to the on-state when a current flows through the diode 52B, for example.

After switching the element unit 52 to the on-state in step S3, the control unit 16, in step S4, causes the voltage conversion unit 30 to start the conversion operation (a voltage step-up operation or a step-down operation) so as to apply an output voltage of a target value to the third conductive path 43 using the first value as the target value. In this manner, when the failure state is entered, the control unit 16 causes the voltage conversion unit 30 to start the conversion operation so as to apply the output voltage of the first value to the third conductive path 43. When the control unit 16 causes the voltage conversion unit 30 to start the above conversion operation using the above first value as the target value in step S4, the above conversion operation is continued using the first value as the target value until the predetermined end condition is satisfied or the processing of step S7 is executed. The predetermined end condition is, for example, that a starting switch of a vehicle has been switched off Note that, if the predetermined end condition is satisfied, control in FIG. 3 is forcefully terminated.

When the voltage conversion unit 30 starts voltage conversion, a current from the voltage conversion unit 30 gradually rises, but, if the load responsiveness of the voltage conversion unit 30 is low, it is difficult to instantly supply a large current. For this reason, immediately after the element unit 52 is switched to the on-state in step S3, a current flows to the second conductive path 42 via the element unit 52. Specifically immediately after the element unit 52 is switched to the on-state in step S3, the voltage conversion unit 30 cannot output a very large current, but it is possible to cause a large current to flow via the element unit 52. Immediately after the element unit 52 is switched to the on-state in step S3, a voltage of a value obtained by subtracting a value Vf corresponding to an amount of drop in voltage that occurs in the diode 52B from the value of an output voltage of the power storage unit 92 (a voltage applied to the first conductive path 41) at the time point when the element unit 52 was switched to the on-state in step S3 is applied to the second conductive path 42 and the third conductive path 43. Then, as time elapses after the element unit 52 was switched to the on-state, a voltage that is applied to the third conductive path 43 by the voltage conversion unit 30 rises, and a current that is supplied to the third conductive path 43 by the voltage conversion unit 30 also rises.

Note that control that is performed by the control unit 16 to cause the voltage conversion unit 30 to start voltage conversion may be performed simultaneously with step S2, or may be performed before step S2. Control that is performed by the control unit 16 to cause the voltage conversion unit 30 to start voltage conversion may be performed simultaneously with step S3, or may be performed before step S3.

After step S4, the control unit 16, in step S5, determines whether or not a predetermined condition is satisfied. Note that, after steps S2, S3, and S4 have been performed, the control unit 16 repeats the determination of “No” in step S5 until the above predetermined condition is satisfied, and repeats the determination of step S5. The above predetermined condition is, for example, that “the voltage of the second conductive path has reached a predetermined value that is higher than or equal to the voltage of the first conductive path”. In a representative example, the predetermined value is the voltage of the first conductive path. That is to say, in a representative example, the predetermined condition is that “the voltage of the second conductive path has reached the voltage of the first conductive path or higher”. Note that the predetermined value may be a value that is different from and larger than the voltage of the first conductive path.

If it is determined that the above predetermined condition is satisfied (if “Yes” in step S5) after steps S2, S3, and S4 have been performed, the control unit 16 switches the element unit 52 to the off-state in step S6. That is to say, immediately after the voltage of the second conductive path 42 has reached the voltage of the first conductive path 41, the element unit 52 is switched to the off-state. When such a switch is performed, in the element unit 52, current-carrying via the opening/closing portion 52A is cut off and only current-carrying via the diode 52B is allowed. In this manner, the power supply control device 10 operates such that flow of a current from the second conductive path 42 side to the power storage unit 92 side is cut off in the element unit 52 when the predetermined condition is satisfied after the above failure state was entered.

After switching the element unit 52 to the off-state in step S6, the control unit 16 switches the target value of the voltage conversion unit 30 to a third value that is smaller than the first value in step S7. In this manner, when the failure state is entered, the control unit 16 causes the voltage conversion unit 30 to perform the conversion operation of applying an output voltage of the first value to the third conductive path 43, and then causes the voltage conversion unit 30 to perform the conversion operation of applying an output voltage of the third value to the third conductive path 43. The third value is larger than the second value (a value obtained by subtracting a value corresponding to an amount of drop in voltage in the element unit 52 from the voltage of the first conductive path 41) at the time point when the target value was switched to the third value in step S7, and is larger than the second value after the time point. Thus, flow of a current via the element unit 52 is suppressed. The timing at which the control unit 16 executes step S7 may be the timing at which the voltage of the second conductive path 42 and the voltage of the third conductive path 43 reach the first value, or a timing after a predetermined time has elapsed from when the voltage of the second conductive path 42 and the voltage of the third conductive path 43 reached the first value. The third value is, for example, 10.2 V.

In this manner, when the state changes from the normal state (a state that is not the failure state) to the failure state, the control unit 16 operates so as to switch the switch unit 60 to the on-state, switch the opening/closing portion 52A to the on-state, and cause the voltage conversion unit 30 to start voltage conversion. After switching the switch unit 60 to the on-state, if a predetermined condition is satisfied in a state where the voltage conversion unit 30 is performing the conversion operation, the control unit 16 operates so as to switch the opening/closing portion 52A to the off-state. Furthermore, after switching the opening/closing portion 52A to the off-state, the control unit 16 causes the voltage conversion unit 30 to perform the conversion operation of applying the output voltage of the third value to the third conductive path 43. The third value is defined as a value larger than the second subtracted value after the target value is switched to the third value in step S7.

### Examples of Effects

When performing a backup operation of supplying power that is based on the power storage unit 92, the power supply control device 10 can use a path extending via the element unit 52 and a path extending via the voltage conversion unit 30. During a period during which sufficient power is not supplied via the path extending via the voltage conversion unit 30, for example, the power supply control device 10 can take measures by quickly supplying power using the path extending via the element unit 52. On the other hand, when the output voltage of the power storage unit 92 drops, measures can be taken by causing the voltage conversion unit 30 to perform a voltage step-up operation, and performing a backup operation so as to apply a desired output voltage to the third conductive path 43. Furthermore, the power supply control device 10 can cut off flow of a current from the power path 80 side to the voltage conversion unit 30 side when the switch unit 60 is in the off-state, and reduce loss when a current flows toward the power path 80 when the switch unit 60 is in the on-state.

The power supply control device 10 is configured such that, when the voltage of the second conductive path 42 is lower than or equal to the second value in the failure state, a current flows from the power storage unit 92 side to the power path 80 side via the element unit 52. That is to say, during a period during which output of the voltage conversion unit 30 does not rise “to an extent where the voltage of the second conductive path 42 exceeds the second value”, power that is based on the power storage unit 92 can be supplied to the power path 80 side via the element unit 52, and thus, during a period during which output of the voltage conversion unit 30 is low, a current can be compensated for using the path extending via the element unit 52. Furthermore, when supply of power from the power source unit 91 to the power path 80 is in the normal state different from the failure state, the control unit 16 can also switch the switch unit 60 to the off-state, and, with such a configuration, it is possible to cut off flow of a current from the power path 80 side to the voltage conversion unit 30 side. Furthermore, after the above failure state has been entered, flow of a current from the second conductive path 42 side to the power storage unit 92 side can be cut off in the element unit 52, and thus, while such a cutoff function is exerted, it is possible to prevent a current that is based on output from the voltage conversion unit 30 from flowing from the second conductive path 42 side to the power storage unit 92 side.

When the failure state is entered, the power supply control device 10 can perform voltage conversion so as to apply an output voltage of the first value to the third conductive path 43, and then switch voltage conversion so as to apply the output voltage of the third value that is smaller than the first value. Thus, after a certain period of time has elapsed, this power supply control device 10 can suppress a voltage that is output by the voltage conversion unit 30, and suppress the output energy.

When the failure state is entered, the power supply control device 10 can operate so as to perform voltage conversion for applying the output voltage of the first value that is larger than the above second value, and bring the voltage of the third conductive path 43 close to a relatively high target voltage (the first value) at an early stage. Furthermore, after a certain period of time has elapsed since the failure state was entered, the power supply control device 10 can suppress the output energy by suppressing a voltage output by the voltage conversion unit 30 to the third value smaller than the above first value. The above third value is a larger value than the second value, and thus flow of a current to the second conductive path 42 side via the element unit 52 is suppressed.

In the power supply control device 10, the element unit 52 is configured such that the diode 52B and the opening/closing portion 52A are provided in parallel, the anode of the diode 52B is connected to the first conductive path 41, and the cathode is connected to the second conductive path 42. Thus, in the element unit 52, even when the opening/closing portion 52A is in the off-state, and the voltage of the second conductive path 42 is lower than the voltage of the first conductive path 41 by a certain value or higher, flow of a current from the first conductive path 41 to the second conductive path 42 is continuously permitted, and when the opening/closing portion 52A is in the on-state, current-carrying via the opening/closing portion 52A is permitted. Furthermore, this power supply control device 10 can supply a larger amount of power via the element unit 52 at an earlier stage while reducing loss in the element unit 52 by switching the opening/closing portion 52A to the on-state when the state changes from the normal state to the failure state. Furthermore, after switching the switch unit 60 to the on-state, this power supply control device 10 switches the opening/closing portion 52A to the off-state in accordance with a predetermined condition being satisfied during the conversion operation. Thus, after the voltage conversion operation has progressed to a point where the predetermined condition is satisfied, this power supply control device 10 can prevent a current from flowing backward in the element unit 52. Furthermore, after switching the opening/closing portion 52A to the off-state, this power supply control device 10 causes the voltage conversion unit 30 to perform the conversion operation of applying the output voltage of the third value (a value that is smaller than the first value and larger than the second subtracted value) to the third conductive path 43. Thus, after a certain period of time has elapsed, this power supply control device 10 can continue power supply through an energy-saving output operation performed by the voltage conversion unit 30 while reliably suppressing a current in a forward direction in the diode 52B.

The above predetermined condition may be that the voltage conversion unit 30 outputs the output voltage of the first value. In this case, after the failure state has been entered, the power supply control device 10 can continue current-carrying via the opening/closing portion 52A until the output voltage that is applied to the third conductive path 43 rises to the first value, and can reliably prevent a backflow in the element unit 52 after the output voltage has risen to the first value.

In the normal state, the power supply control device 10 can prepare for a failure state by causing the voltage conversion unit 30 to perform conversion operation, and, in the meanwhile, cut off flow of a current from the voltage conversion unit 30 to the power path 80 by cutting off bidirectional current-carrying in the switch unit 60 at the time of such preparation.

### Modified Example 1 of First Embodiment

In a representative example of the first embodiment, an example of a predetermined condition has been illustrated, but the above predetermined condition may also be that “a predetermined time has elapsed from when the voltage conversion unit 30 started to output a current to the third conductive path 43 after the above failure state was entered”. The content of modified example 1 can be the same as the first embodiment except for the predetermined condition.

This power supply control device 10 can continue current-carrying via the opening/closing portion 52A until when a predetermined time elapses from when the voltage conversion unit 30 started outputting a current after the above failure state was entered, and can reliably prevent a backflow in the element unit 52 after the predetermined time has elapsed.

### Modified Example 2 of First Embodiment

In a representative example of the first embodiment, an example of a predetermined condition has been illustrated, but the above predetermined condition may also be that “flow of a current through the element unit 52 has dropped to or below a lower limit value”. The content of modified example 2 can be the same as the first embodiment except for the predetermined condition.

This power supply control device 10 can allow current-carrying via the opening/closing portion 52A until a current flowing through the element unit 52 drops to or below the lower limit value after the above failure state was entered, and can reliably prevent a backflow in the element unit 52 when a current flowing through the element unit 52 drops to or below the lower limit value.

### Modified Example 3 of First Embodiment

In a representative example of the first embodiment, an example of a predetermined condition has been illustrated, but the above predetermined condition may also be that “a current that is output to the third conductive path 43 by the voltage conversion unit 30 reaches a reference value or larger after the above failure state was entered”. The content of modified example 3 can be the same as the first embodiment except for the predetermined condition.

This power supply control device 10 can allow current-carrying via the opening/closing portion 52A until a current that is output to the third conductive path 43 by the voltage conversion unit 30 reaches a reference value or larger after the above failure state was entered, and can reliably prevent a backflow in the element unit 52 when a current that is output to the third conductive path 43 by the voltage conversion unit 30 has reached the reference value or larger.

### Second Embodiment

The following description is directed to a second embodiment.

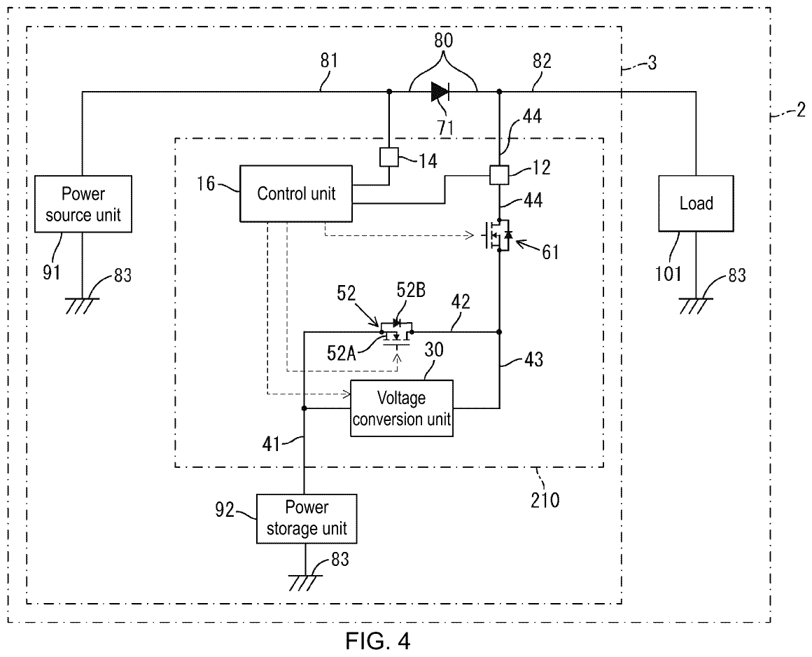

A power supply control device 210 according to the second embodiment shown in FIG. 4 is different from the power supply control device 10 according to the first embodiment only in that the switch element 62 is omitted from the configuration in FIG. 1, and is the same as the power supply control device 10 according to the first embodiment in other respects.

As shown in FIG. 4, in the power supply control device 210 according to the second embodiment, the switch element 61 corresponds to a switch unit. The body diode of the switch element 61 corresponds to an example of a second diode, the anode of this body diode is electrically connected to the third conductive path 43, and the cathode is electrically connected to the power path 80. The cathode of this body diode may be short-circuited such that the potential thereof is the same as the potential of the second power path 82, or may be connected to the second power path 82 via the current detection unit 12 as shown in FIG. 4. In the configuration in FIG. 4, in a case where the voltage of the power path 80 drops below the voltage of the third conductive path 43 by a certain value or more when the switch unit 60 is in the off-state, a current flows from the third conductive path 43 side to the power path 80 side via the above body diode. Note that control for a backup operation that is performed by the power supply control device 210 according to the second embodiment is the same as the first embodiment, and is performed in a flow such as that shown in FIG. 3.

### Third Embodiment

The following description is directed to a third embodiment.

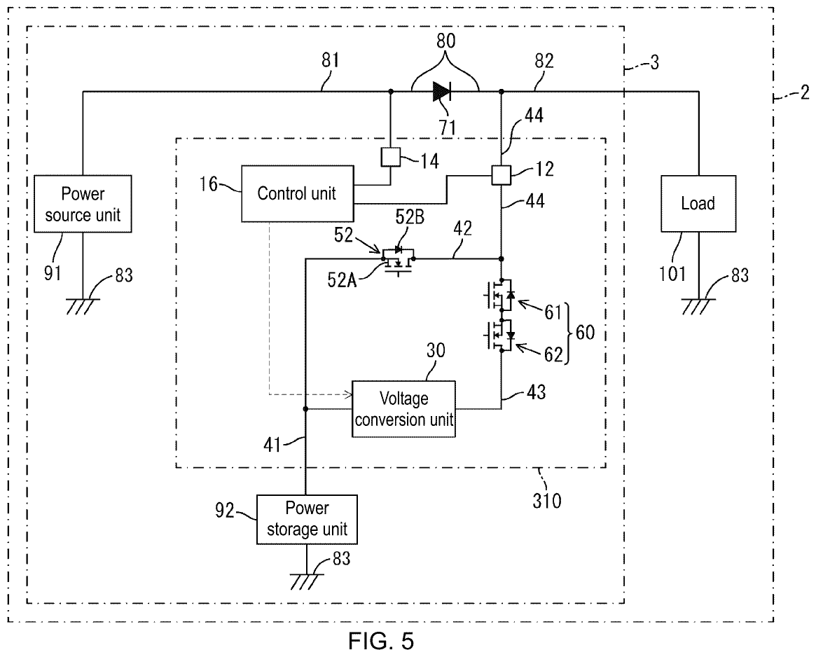

A power supply control device 310 according to the third embodiment shown in FIG. 5 is different from the power supply control device 10 according to the first embodiment only in that the position of the switch unit 60 is changed from the configuration in FIG. 1, and is the same as the power supply control device 10 according to the first embodiment in other respects.

In the power supply control device 310 in FIG. 5, the other end of the second conductive path 42 is electrically connected to the fourth conductive path 44. With this configuration, when the switch unit 60 is in the on-state, the second conductive path 42 and the third conductive path 43 are short-circuited to each other via the switch unit 60. Note that control for a backup operation that is performed by the power supply control device 310 according to the third embodiment is the same as the first embodiment, and is performed in a flow such as that shown in FIG. 3.

### Fourth Embodiment

The following description is directed to a fourth embodiment.

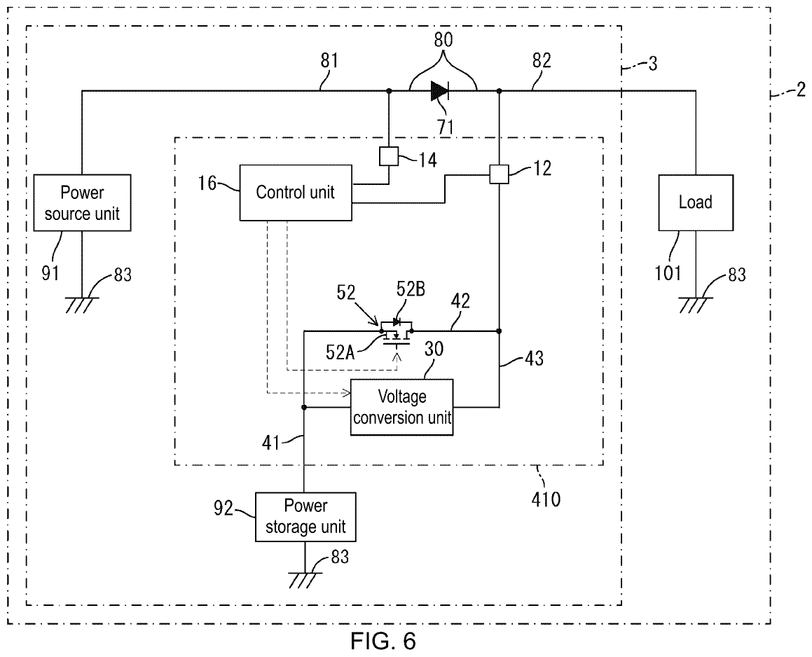

A power supply control device 410 according to the fourth embodiment shown in FIG. 6 is different from the power supply control device 10 according to the first embodiment only in that the switch unit 60 is omitted from the configuration in FIG. 1, and is the same as the power supply control device 10 according to the first embodiment in other respects.

In the power supply control device 410 in FIG. 6, the second conductive path 42 and the third conductive path 43 are short-circuited to each other. The second conductive path 42 and the third conductive path 43 are electrically connected to the power path 80 in a configuration of being short-circuited to the power path 80. In the configuration in FIG. 6, when the voltage of the power path 80 drops, the voltage of the second conductive path 42 also drops, and, when the voltage of the second conductive path 42 drops to or below the second value, a current flows from the power storage unit 92 side to the power path 80 side via the diode 52B of the element unit 52. That is to say, the power supply control device 410 in FIG. 6 can more quickly supply power using the path extending via the element unit 52 when the voltage of the second conductive path 42 drops to or below the second value in the failure state.

Control for a backup operation that is performed by the power supply control device 410 according to the fourth embodiment is the processing in FIG. 3 with step S2 omitted. When the voltage of the second conductive path 42 drops to or below the second value in the failure state, the power supply control device 410 in FIG. 6 can instantly start power supply via the diode 52B even before the opening/closing portion 52A is switched to the on-state in step S3. Furthermore, this power supply control device 410 can supply a larger amount of power via the element unit 52 while reducing loss in the element unit 52 by the opening/closing portion 52A being switched to the on-state. Furthermore, this power supply control device 410 causes the voltage conversion unit 30 to start the conversion operation in step S4. Thus, when the output voltage of the power storage unit 92 drops, measures can be taken by causing the voltage conversion unit 30 to perform a voltage step-up operation, and performing a backup operation so as to apply a desired output voltage to the third conductive path 43. Furthermore, when the failure state is entered, the power supply control device 410 can operate such that voltage conversion is performed so as to apply the output voltage of the first value that is larger than the above second value, and the voltage of the third conductive path 43 is brought closer to a relatively high target voltage (first value).

### Fifth Embodiment

The following description is directed to a fifth embodiment.

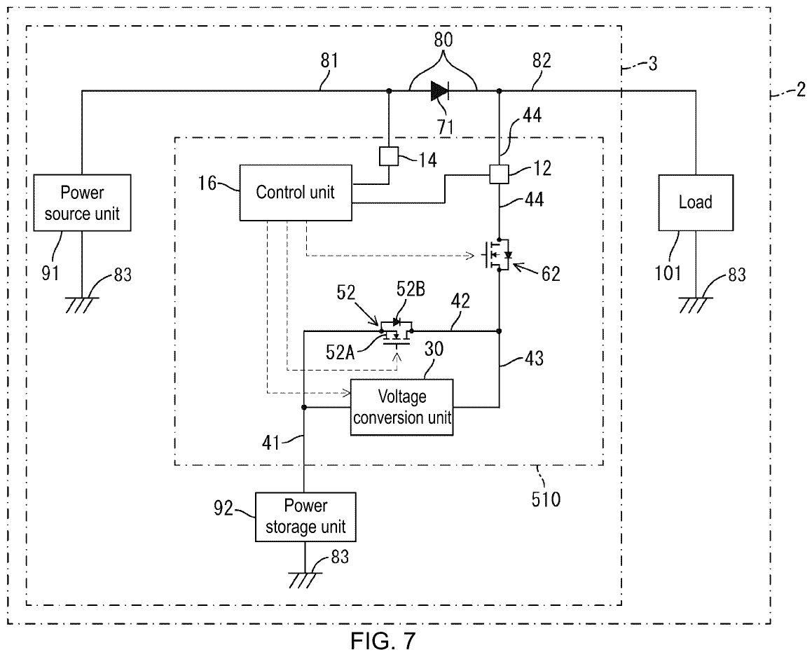

A power supply control device 510 according to the fifth embodiment shown in FIG. 7 has a configuration in which the switch element 62 shown in FIG. 1 is added to the configuration in FIG. 6, and is the same as the power supply control device 410 according to the fourth embodiment in other respects.

As shown in FIG. 7, in the power supply control device 510 according to the fifth embodiment, the switch element 62 corresponds to the switch unit. In the power supply control device 410 according to the fourth embodiment, for example, in a configuration in which output voltage of the power storage unit 92 is higher than output voltage of the power source unit 91 irrespective of the fact that the state is not the failure state, a current may flow from the power storage unit 92 side to the power path 80 side via the diode 52B, resulting in consumption of power of the power storage unit 92. In contrast, the power supply control device 510 shown in FIG. 7 can cut off flow of a current from the power storage unit 92 side to the power path 80 side via the diode 52B using the body diode of the switch element 62. After the failure state is entered, as a result of the switch element 62 corresponding to the switch unit being switched to the on-state in step S2 in FIG. 3, power is quickly supplied from the power storage unit 92 side to the power path 80 side via the diode 52B.

### OTHER EMBODIMENTS

The present disclosure is not limited to the embodiments described above with reference to the drawings. Any combination of the features of the embodiments described above and below is possible as long as no contradictions arise. In addition, any features of the embodiment described above and below can be omitted unless explicitly stated as being essential. Furthermore, the above embodiments may be changed as follows.

In the above embodiments, the power storage unit 92 is provided outside the power supply control device 10, but a configuration may be adopted in which the power storage unit 92 is included in the power supply control device 10.

In the above embodiments, the switch unit 60 is configured by an FET, but the switch unit may be configured by a semiconductor switch different from an FET, or may be configured by a mechanical relay.

In the above embodiments, the switch elements T1, T2, T3, and T4 that constitute the voltage conversion unit are configured by FETs, but may be configured by semiconductor switches different from FETs.

In the above embodiments, a state where the voltage of the first power path 81 drops to or below a threshold value is defined as a failure state, but there is no limitation to this example. For example, a state where a drop in voltage that exceeds a specified value occurs on the first power path 81 within a predetermined time may be defined as the failure state, or determination may be performed on the failure state using another determination method.

In the above embodiments, the diode 71 is provided, but a switch such as an FET may be provided in place of the diode 71. In this case, it suffices for a configuration in which a switch is instantly turned off when a failure state occurs to be provided.

In the above embodiments, the element unit 52 is configured by an FET, but the element unit may be configured such that a diode is provided in place of the FET, the anode of this diode is connected to the first conductive path 41, and the cathode is connected to the second conductive path 42. In this case, in control in FIG. 3, it suffices for the processing of steps S3 and S6 to be omitted.

In the above embodiments, a configuration is adopted in which, when the switch unit 60 is in the on-state, the second conductive path 42 and the third conductive path 43 are short-circuited to each other via the switch unit or without the switch unit interposed therebetween, and the above second value is defined as a value obtained by subtracting a value corresponding to an amount of drop in voltage that occurs in the element unit 52 when a current flows from the first conductive path 41 to the second conductive path 42 through the element unit 52, from the value of a voltage that is applied to the first conductive path 41. In the above embodiments, in those having such a configuration, the above third value is smaller than the above first value and larger than the above second value, but there is no limitation to this example, and the above third value may be smaller than the above first value and second value. Specifically, if the second value is a value obtained by subtracting “a value corresponding to a drop in voltage that occurs in the element unit 52 in a case where a current flows from the first conductive path 41 to the second conductive path 42 when the element unit 52 is in the on-state”, from the value of a voltage that is applied to the first conductive path 41, the third value may be smaller than this second value. In this example, the same hardware configuration as any of the above embodiments is adopted, and the processing of step S7 in FIG. 3 may then be changed such that the third value is changed to a value smaller than the second value, or the following change may be made. For example, the element unit 52 is changed from the configuration in the first embodiment in FIG. 1 to a configuration in which bidirectional current-carrying is cut off in the off-state and bidirectional current-carrying is allowed in the on-state (for example, a configuration similar to that of the switch unit 60), bidirectional current-carrying is then cut off in the element unit by switching the element unit to the off-state in step S6 in FIG. 3, and the third value may then be changed to a value smaller than the first value and second value in step S7. In this example, after a certain period of time has elapsed from when the failure state was entered, the output energy can be suppressed by suppressing a voltage that is output by the voltage conversion unit to the third value, and the output energy can be suppressed further by setting the third value to a value smaller than the second value. At this time, a flow from the first conductive path 41 side to the second conductive path 42 side is cut off in the element unit.

The embodiments disclosed herein are exemplary in all respects and should not be interpreted as limiting. The scope of the present disclosure is not limited to the embodiments disclosed herein, and is intended to include all modifications that are within the meanings and the scope that are equivalent to those of the claims.

1. A power supply control device that is used in an on-board system including: a power source unit configured to supply power; a power path through which power that is based on the power source unit is transmitted; and a power storage unit different from the power source unit, and controls power supply from the power storage unit, the power supply control device comprising:
a first conductive path to which a voltage that is based on output of the power storage unit is applied;
an element unit that is electrically connected at one end to the first conductive path;
a second conductive path that is electrically connected to the other end of the element unit, and forms a current-carrying path between the element unit and the power path;
a voltage conversion unit that is connected in parallel with the element unit between the power storage unit and the power path, and is configured to perform a conversion operation of stepping up or down an input voltage that is based on power from the power storage unit;
a third conductive path that is electrically connected to the voltage conversion unit between the voltage conversion unit and the power path; and
a control unit configured to control the voltage conversion unit,
wherein the element unit is capable of allowing flow of a current to the power path side via the element unit itself and cutting off flow of a current to the power storage unit side via the element unit itself, and
the control unit stops the voltage conversion unit when supply of power from the power source unit to the power path is in a normal state different from a failure state, and causes the voltage conversion unit to start the conversion operation when the failure state is entered.

2. The power supply control device according to claim 1,
wherein, when the failure state is entered, the control unit causes the voltage conversion unit to start the conversion operation so as to apply an output voltage of a first value to the third conductive path,
when a voltage of the second conductive path is lower than or equal to a second value in the failure state, a current flows from the power storage unit side to the power path side via the element unit, and
at least after the failure state has been entered, flow of a current from the second conductive path side to the power storage unit side is cut off in the element unit.

3. The power supply control device according to claim 2, wherein, after causing the voltage conversion unit to start the conversion operation of applying the output voltage of the first value to the third conductive path when the failure state is entered, the control unit causes the voltage conversion unit to perform the conversion operation of applying an output voltage of a third value that is smaller than the first value to the third conductive path.

4. The power supply control device according to claim 3,
wherein the second conductive path and the third conductive path are short-circuited to each other,
the second value is a value obtained by subtracting a value corresponding to an amount of drop in voltage that occurs in the element unit from a value of a voltage that is applied to the first conductive path,
the first value is larger than the second value, and
the third value is smaller than the first value and larger than the second value.

5. The power supply control device according to claim 3,
wherein the second conductive path and the third conductive path are short-circuited to each other,
the second value is a value obtained by subtracting a value corresponding to an amount of drop in voltage that occurs in the element unit when a current flows from the first conductive path to the second conductive path through the element unit, from a value of a voltage that is applied to the first conductive path, and
the third value is smaller than the first value and the second value.

6. The power supply control device according to claim 4,
wherein the element unit includes a diode and an opening/closing portion provided in parallel with the diode,
a voltage that is based on output of the power storage unit is applied to an anode of the diode,
a cathode of the diode is electrically connected to the second conductive path,
in an on-state, bidirectional current-carrying is allowed in the opening/closing portion,
when the opening/closing portion is in the on-state, the second value is a first subtracted value obtained by subtracting a value corresponding to an amount of drop in voltage that occurs in the opening/closing portion and the diode, from a value of a voltage that is applied to the first conductive path, and, when the opening/closing portion is in an off-state, the second value is a second subtracted value obtained by subtracting a value corresponding to an amount of drop in voltage that occurs in the diode, from the value of the voltage that is applied to the first conductive path,
the first value is larger than both the first subtracted value and the second subtracted value,
when a state changes from the normal state to the failure state, the control unit switches the opening/closing portion to the on-state and causes the voltage conversion unit to start the conversion operation of applying the output voltage of the first value to the third conductive path, then switches the opening/closing portion to the off-state if a predetermined condition is satisfied in a state where the voltage conversion unit is performing the conversion operation, and, after switching the opening/closing portion to the off-state, causes the voltage conversion unit to perform the conversion operation of applying the output voltage of the third value to the third conductive path, and
the third value is larger than the second subtracted value.

7. The power supply control device according to claim 6, wherein the predetermined condition is that the voltage of the second conductive path has reached a predetermined value that is higher than or equal to a voltage of the first conductive path.

8. The power supply control device according to claim 6, wherein the predetermined condition is that a predetermined time has elapsed from when the voltage conversion unit started the conversion operation after the failure state was entered.

9. The power supply control device according to claim 6, wherein the predetermined condition is that a current flowing through the element unit has dropped to or below a lower limit value.

10. The power supply control device according to claim 6, wherein the predetermined condition is that a current output to the third conductive path by the voltage conversion unit after the failure state was entered has reached a reference value or larger.
